(19) United States
(12) Patent Application Publication
(10) Pub. No.: US 2024/0258621 A1
(43) Pub. Date: Aug. 1, 2024

(54) HOUSING FOR ELECTRONIC COMPONENTS AND POWER SUPPLY DEVICE

(71) Applicant: Murata Manufacturing Co., Ltd., Nagaokakyo-shi (JP)

(72) Inventor: Masanobu OKADA, Nagaokakyo-shi (JP)

(21) Appl. No.: 18/630,212

(22) Filed: Apr. 9, 2024

Related U.S. Application Data
(63) Continuation of application No. PCT/JP2022/042592, filed on Nov. 16, 2022.

(30) Foreign Application Priority Data
Nov. 25, 2021 (JP) 2021-191225

(51) Int. Cl. H01M 50/209; H01M 50/284

(52) U.S. Cl. CPC H01M 50/209; H01M 50/284

(57) ABSTRACT

A housing for electronic components includes a first plate portion, a second plate portion, a third plate portion, and a fourth plate portion. At least one of the third plate portion and the fourth plate portion has a band-shaped convex portion including a band-shaped plateau portion, and a band-shaped first bent portion and a band-shaped second bent portion that are located on either side of the plateau portion. The first bent portion includes a first slope portion that is in contact with an edge of the plateau portion at or adjacent to the first plate portion and extends from the plateau portion toward the first plate portion. The second bent portion includes a second slope portion that is in contact with an edge of the plateau portion at or adjacent to the second plate portion and extends from the plateau portion toward the second plate portion while being inclined in a direction opposite to a direction in which the first slope portion is inclined.

### CROSS REFERENCE TO RELATED APPLICATIONS

This application claims the benefit of priority to Japanese Patent Application No. 2021-191225 filed on Nov. 25, 2021 and is a Continuation application of PCT Application No. PCT/JP2022/042592 filed on Nov. 16, 2022. The entire contents of each application are hereby incorporated herein by reference.

### BACKGROUND OF THE INVENTION

### 1. Field of the Invention

The present technology relates to housings for electronic components and power supply devices.

### 2. Description of the Related Art

A housing for electronic components protects electronic components (for example, a secondary battery and a circuit board) in the housing when pressure is applied due to vibration or dropping during transportation (see, for example, Japanese Unexamined Utility Model Registration Application No. 5-12718).

### SUMMARY OF THE INVENTION

However, in the invention described in Japanese Unexamined Utility Model Registration Application No. 5-12718, when pressure is applied due to, for example, vibration or dropping during transportation, the housing may dent toward the accommodation space, and the pressure may also be applied to electronic components in the housing. Particularly in a housing for electronic components, since the electronic components accommodated therein are fixed to the outside wall of the housing with screws, deformation of the outside wall is likely to be transferred to the electronic components. Accordingly, in a housing for electronic components, measures to prevent the housing from being deformed inward need be taken. Accordingly, it is desirable to provide a housing for electronic components that can reduce pressure applied to the electronic components in the housing and a power supply device including such a housing for electronic components.

A housing for electronic components according to an example embodiment of the present technology includes a first plate portion and a second plate portion that are spaced apart from each other in a first direction, and a third plate portion and a fourth plate portion that are spaced apart from each other in a second direction perpendicular or substantially perpendicular to the first direction. At least one of the third plate portion and the fourth plate portion includes a band-shaped convex portion that projects outward from the housing and extends to reach both edges in a third direction perpendicular or substantially perpendicular to the first direction and the second direction. The convex portion includes a band-shaped plateau portion that extends in the third direction and a band-shaped first bent portion and a band-shaped second bent portion that are located on either side of the plateau portion in the first direction and extend in the third direction. The first bent portion includes a first slope portion that is in contact with an edge at or adjacent to the first plate of the plateau portion and extends from the plateau portion toward the first plate portion in the first direction. The second bent portion includes a second slope portion in contact with an edge of the plateau portion at or adjacent to the second plate portion and extends from the plateau portion toward the second plate portion in the first direction while being inclined in a direction opposite to a direction in which the first slope portion is inclined.

A power supply device according to an example embodiment of the present technology includes a battery unit and a housing for battery units in which the battery unit is accommodated. The housing for battery units has the same structure as the housing for electronic components described above.

In the housing for electronic components and the power supply device according to the example embodiments of the present technology, at least one of the third plate portion and the fourth plate portion has a band-shaped convex portion that extends to reach both edges in the third t direction perpendicular or substantially perpendicular to the first direction and the second direction. The convex portion includes a first bent portion having a first slope portion extending from the plateau portion of the convex portion toward the first plate portion in the first direction and a second bent portion including a second slope portion extending from the plateau portion of the convex portion toward the second plate portion in the first direction while being inclined in a direction opposite to a direction in which the first slope portion is inclined. As a result, when pressure is applied due to, for example, vibration or dropping during transportation, pressure applied to the electronic components in the housing can be reduced.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view illustrating the structure of a power supply device including a housing according to an example embodiment of the present technology.

FIG. 2 is a perspective view illustrating the structure of a portion of the housing in FIG. 1.

FIG. 3 is a perspective view illustrating the structure of a side plate portion in FIG. 1.

FIG. 4A is a perspective view illustrating a state in which external pressure is applied to the housing in FIG. 1. FIG. 4B is a perspective view illustrating a state in which the housing is deformed by external pressure applied.

FIG. 5 is a perspective view illustrating a modification of the structure of a portion of the housing in FIG. 1.

### DETAILED DESCRIPTION OF THE EXAMPLE EMBODIMENTS

Example embodiments of the present technology will be described in detail with reference to the drawings.

### 1. Example Embodiments

### Structure

The structure of a power supply device 1 including a housing 40 according to an example embodiment of the present technology will be described.

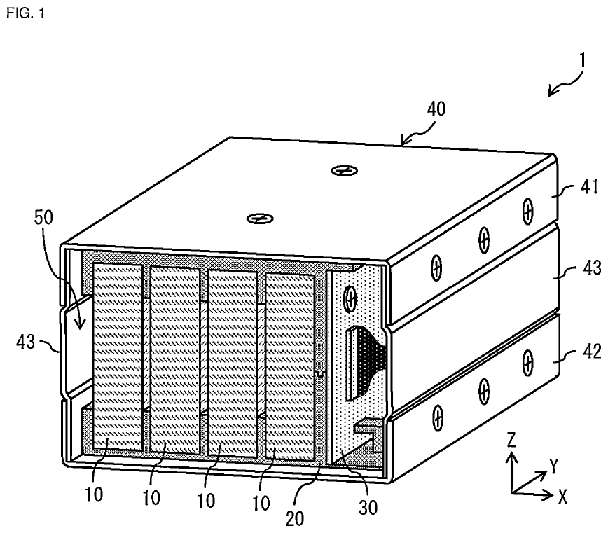

FIG. 1 is a perspective view illustrating the structure of the power supply device 1. As illustrated in, for example, FIG. 1, the power supply device 1 includes a plurality of battery units 10, a supporting body 20, a circuit board 30, and the housing 40.

The battery unit 10 is a battery block in which a plurality of unit cells (secondary batteries) are connected to each other. The type of the secondary batteries is not particularly limited but is, for example, a lithium-ion secondary battery. The number of the secondary batteries included in the battery unit 10 is not particularly limited and can be set arbitrarily. The supporting body 20 includes a shelf that supports the plurality of battery units 10 and accommodates the battery units 10 therein and is in contact with the inner wall of the housing 40. The supporting body 20 is fixed to the housing 40 with, for example, screws. The circuit board 30 supplies electric power from the plurality of battery units 10 to an external circuit or charges the plurality of battery units 10 with electric power from an external circuit. The housing 40 is a housing for electronic components (or for battery units) in which the plurality of battery units 10, the supporting body 20, and the circuit board 30 are accommodated. The plurality of battery units 10, the supporting body 20, and the circuit board 30 are accommodated in an accommodation space 50 of the housing 40.

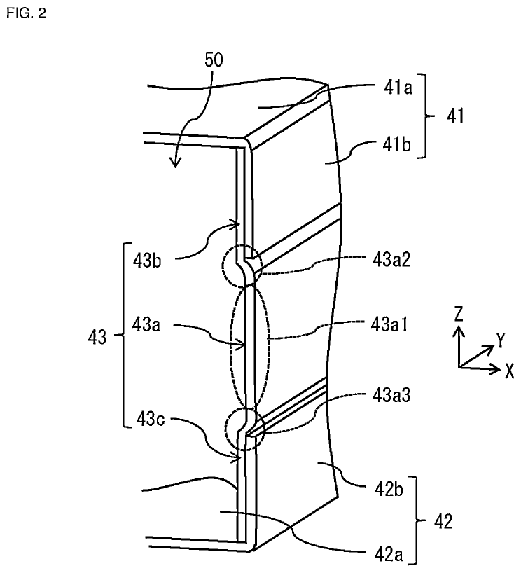

FIG. 2 is a perspective view illustrating the structure of a portion of the housing 40. As illustrated in, for example, FIGS. 1 and 2, the housing 40 includes an upper plate portion 41 (first plate portion), a lower plate portion 42 (second plate portion), and a pair of side plate portions 43 (third plate portion and fourth plate portion). The upper plate portion 41 and the lower plate portion 42 are provided with the accommodation space 50 (a predetermined gap) therebetween in a Z-direction (first direction) and, for example, face each other in the Z-direction with the accommodation space 50 therebetween. The third plate portion and the fourth plate portion are provided with the accommodation space 50 therebetween in an X-direction (second direction) perpendicular or substantially perpendicular to the Z-direction and, for example, face each other in the X-direction with the accommodation space 50 therebetween. The third plate portion and the fourth plate portion are in contact with the upper plate portion 41 and the lower plate portion 42. The upper plate portion 41, the lower plate portion 42, and the pair of side plate portions 43 are configured to accommodate a plurality of secondary batteries 10, a supporting body 20, and a circuit board 30. The accommodation space 50 is defined by the upper plate portion 41, the lower plate portion 42, and the pair of side plate portions 43. The upper plate portion 41, the lower plate portion 42, and the pair of side plate portions 43 are made from separate metal plates and each have a planar shape.

As illustrated in, for example, FIGS. 1 and 2, the upper plate portion 41 includes an upper lid portion 41a that defines the upper surface of the housing 40 and two folded portions 41b that define some portions of the side surfaces of the housing 40. The two folded portions 41b are coupled to both respective end portions of the upper lid portion 41a in the X-axis direction. Each of the folded portions 41b is in contact with the surface of the end portion (an upper-side plate portion 43b described later) of the side plate portion 43 at or adjacent to the upper lid portion 41a and overlaps at least a portion of the upper-side plate portion 43b in the X-direction. Accordingly, the upper plate portion 41 has a U-shape. The upper plate portion 41 is defined by, for example, a bent single metal sheet. The U-shape is not limited to a shape including arcs and may be a shape including corners.

The folded portion 41b may overlap the entire upper-side plate portion 43b, as illustrated in, for example, FIG. 2. At this time, the end portion of the folded portion 41b is located at or adjacent to an upper-side bent portion 43a2, which will be described later, with a predetermined gap therebetween in the Z-direction. In this case, when the upper-side bent portion 43a2 is deformed by, for example, pressure in the Z-direction, the end portion of the folded portion 41b may come into contact with the upper-side bent portion 43a2.

As illustrated in, for example, FIGS. 1 and 2, the lower plate portion 42 includes a bottom lid portion 42a that defines the bottom surface of the housing 40 and two folded portions 42b that define some portions of the side surfaces of the housing 40. The two folded portions 42b are coupled to both respective end portions of the bottom lid portions 42a in the X-axis direction. One of the folded portions 42b is in contact with the surface of the end portion (a lower-side plate portion 43c described later) of one of the side plate portions 43 at or adjacent to the bottom lid portion 42a and overlaps at least a portion of the lower-side plate portion 43c. The other of the folded portions 42b is in contact with the surface of the end portion (the lower-side plate portion 43c described later) of the other of the side plate portions 43 at or adjacent to the bottom lid portion 42a and overlaps at least a portion of the lower-side plate portion 43c. Accordingly, the lower plate portion 42 has a U-shape. The lower plate portion 42 is defined by, for example, a bent single metal sheet.

The folded portion 42b may overlap the entire lower-side plate portion 43c as illustrated in, for example, FIG. 2. At this time, the end portion of the folded portion 42b is located at or adjacent to a lower-side bent portion 43a3, which will be described later, with a predetermined gap therebetween in the Z-direction. In this case, when the lower-side bent portion 43a3 is deformed by, for example, pressure in the Z-direction, the end portion of the folded portion 42b may come into contact with the lower-side bent portion 43a3.

The side plate portion 43 includes a convex portion 43a that projects outward from the housing 40, as illustrated in, for example, FIGS. 1 and 2. The convex portion 43a has a band shape that extends to reach both edges of the side plate portion 43 in the Y-direction (third direction) perpendicular or substantially perpendicular to the Z-direction (first direction) and the X-direction (second direction). The convex portion 43a includes a plateau portion 43al, an upper-side bent portion 43a2 (first bent portion), and a lower-side bent portion 43a3 (second bent portion). The plateau portion 43a1, the upper-side bent portion 43a2, and the lower-side bent portion 43a3 have a band shape that extends in the extension direction (for example, the Y-direction) of the convex portion 43a. The upper-side bent portion 43a2 and the lower-side bent portion 43a3 are located on either side of the plateau portion 43al in a direction (for example, the Z-direction) perpendicular or substantially perpendicular to the extension direction of the convex portion 43a.

The upper-side bent portion 43a2 is in contact with an edge of the plateau portion 43al at or adjacent to the first plate portion 41 and is inclined downward to the first plate section 41 from the plateau portion 43al in the Z-direction. That is, the surface of the upper-side bent portion 43a2 is an inclined surface (first slope portion). The lower-side bent portion 43a3 is in contact with an edge of the plateau portion 43al at or adjacent to the second plate portion 42 and is inclined downward to the second plate portion 42 from the plateau portion 43al in the Z-direction. That is, the surface of the lower-side bent portion 43a3 is an inclined surface (the second slope portion inclined in a direction opposite to a direction in which the first slope portion is inclined).

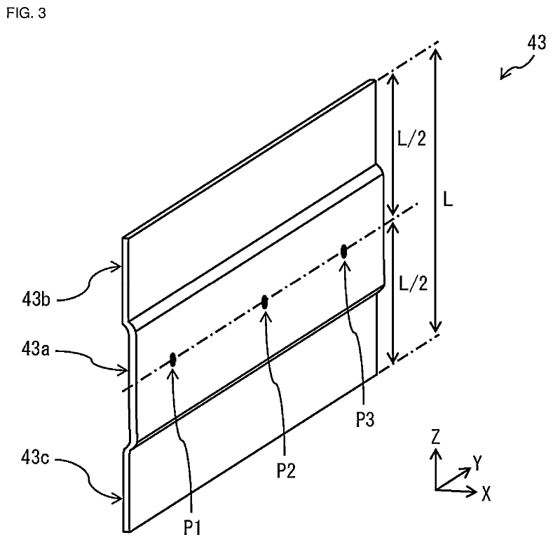

The plateau portion 43al of the convex portion 43a is, for example, a flat surface. The plateau portion 43al of the convex portion 43a is located at a position including the middle portion of the side plate portion 43 in the Z-direction. The middle portion of the side plate portion 43 in the Z-direction corresponds to the midpoint of the side plate portion 43 in the Z-direction. When the distance between the edge (the edge of the side plate portion 43 at or adjacent to the upper-side plate portion 43b) of the upper-side plate portion 43b and the edge (the edge of the side plate portion 43 at or adjacent to the lower-side plate portion 43c) of the lower-side plate portion 43c is L, the midpoint of the side plate portion 43 in the Z-direction is located at a distance of about L/2 from the edge of the upper-side plate portion 43b and the edge of the lower-side plate portion 43c. The midpoint of the side plate portion 43 in the Z-direction is not limited to the middle portion of the side plate portion 43 in the Y-direction. Three midpoints P1, P2, and P3 are illustrated in FIG. 3 as the midpoints of the side plate portion 43 in the Z-direction. The midpoint P1 is located near one of the edges of the side plate portion 43 in the Y-direction. The midpoint P3 is located near the other of the edges of the side plate portion 43 in the Y-direction. The midpoint P2 is located between the midpoint P1 and the midpoint P3. As illustrated in, for example, FIG. 3, the plateau portion 43al of the convex portion 43a is located at a position including the three midpoints P1, P2, and P3. It should be noted that the plateau portion 43al of the convex portion 43a may be located at a position including at least one of the three midpoints P1, P2, and P3. It should be noted that the three midpoints P1, P2, and P3 are virtual. In addition, in FIG. 3, cavities into which screws are inserted and the like are not described. It should be noted that an end portion corresponds to an end portion in the Z-direction. When a concave or convex portion is provided at an end portion, the tip of the convex portion is an end portion.

The upper-side bent portion 43a2 and the lower-side bent portion 43a3 of the convex portion 43a are symmetrical with respect to the middle portion of the side plate portion 43 in the Z-direction. In addition, the upper-side bent portion 43a2 and the lower-side bent portion 43a3 of the convex portion 43a are symmetrical with respect to the middle portion of the convex portion 43a in the Z-direction.

The side plate portion 43 further includes the upper-side plate portion 43b and the lower-side plate portion 43c as illustrated in, for example, FIGS. 1 and 2. The upper-side plate portion 43b is an end portion (the fifth plate portion parallel or substantially parallel to the first direction) of the side plate portion 43 parallel or substantially parallel to the Z-direction and extends from the upper-side bent portion 43a2 of the convex portion 43a. The lower-side plate portion 43c is an end portion (the sixth plate portion parallel or substantially parallel to the first direction) of the side plate portion 43 parallel or substantially parallel to the Z-direction and extends from the lower-side bent portion 43a3 of the convex portion 43a. At least a portion of the upper-side plate portion 43b overlaps an end portion (folded portion 41b) at or adjacent to the side plate portion 43. At least a portion of the lower-side plate portion 43c overlaps an end portion (folded portion 42b) at or adjacent to the side plate portion 43. The portions of the upper-side plate portion 43b and the folded portion 41b that are in contact with each other are, for example, flat surfaces. The portions of the lower-side plate portion 43c and the folded portion 42b that are in contact with each other are, for example, flat surfaces. The side plate portion 43 is defined by, for example, a bent single metal sheet.

The end surface (the end surface of the upper-side plate portion 43b) of the side plate portion 43 at or adjacent to the upper plate portion 41 is in contact with the surface of the upper plate portion 41 at or adjacent to the lower plate portion 42, and the end surface (the end surface of the lower-side plate portion 43c) of the side plate portion 43 at or adjacent to the lower plate portion 42 is in contact with the surface of the lower plate portion 42 at or adjacent to the upper plate portion 41. The folded portion 41b and the upper-side plate portion 43b are stacked together and are fixed to each other with, for example, screws. The folded portion 42b and the lower-side plate portion 43c are stacked together and are fixed to each other with, for example, screws. The surface of the upper plate portion 41 at or adjacent to the lower plate portion 42 is in contact with the supporting body 20, and the upper plate portion 41 is fixed to the supporting body 20 with, for example, screws. The surface of the lower plate portion 42 at or adjacent to the upper plate portion 41 is in contact with the supporting body 20, and the lower plate portion 42 is fixed to the supporting body 20 with, for example, screws.

In addition, a secondary battery that can be used as the battery unit 10 may be, for example, a secondary battery having a capacity exceeding approximately several hundred mAh, which has a risk of actual thermal runaway during occurrence of an internal short circuit. An example of a secondary battery having a capacity exceeding approximately several hundred mAh includes a laminated battery or a cylindrical battery. The charging/discharging system of the secondary battery is not particularly limited, but the secondary battery is configured to obtain battery capacity by, for example, absorbing and releasing electrode reactants. The secondary battery includes, for example, a positive electrode, a negative electrode, and an electrolyte.

The types of electrode reactants are not particularly limited but are specifically light metals, such as an alkali metal or an alkaline earth metal. Alkali metals include lithium, sodium, potassium, and the like, and alkaline earth metals include beryllium, magnesium, calcium, and the like. A secondary battery that obtains battery capacity by absorbing and releasing lithium is a so-called lithium-ion secondary battery. In a lithium-ion secondary battery, lithium in an ionized state is absorbed and released.

When, for example, a foreign object (for example, a nail or a metallic piece) pierces the secondary battery from outside and a short circuit (referred to below as an internal short circuit) between the positive and negative electrodes occurs, Joule heat is generated around the short circuit. Depending on the state of occurrence of Joule heat, thermal runaway may occur in the secondary battery. Such an internal short circuit in the secondary battery due to a foreign object can occur when pressure is applied to the secondary battery due to, for example, vibration or dropping during transportation. Accordingly, when the secondary battery is accommodated in the housing, pressure need be prevented from being applied to the secondary battery accommodated in the housing. Accordingly, the inventor of the present application proposes the housing 40 that can reduce pressure applied to the accommodated object.

### Impact Resistance

Next, impact resistance of the housing 40 will be described.

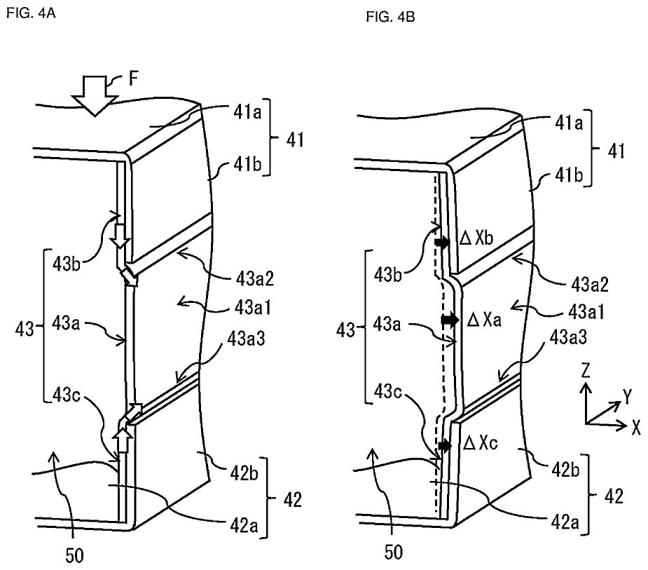

FIG. 4A is a perspective view illustrating a state in which external pressure is applied to the upper plate portion 41. FIG. 4B is a perspective view illustrating a state in which the housing 40 is deformed by external pressure applied to the upper plate portion 41.

As indicated by open arrows in FIG. 4A, when external pressure is applied to the upper plate portion 41, the pressure propagates to the upper-side plate portion 43b that supports the upper plate portion 41 and to the lower-side plate portion 43c that supports the lower plate portion 42. As a result, as illustrated in, for example, FIG. 4B, the upper-side bent portion 43a2 and the lower-side bent portion 43a3 are deformed, and the pressure that has been propagated through the upper-side plate portion 43b and the lower-side plate portion 43c is relieved. The pressure that cannot be canceled by the deformation of the upper-side bent portion 43a2 and the lower-side bent portion 43a3 causes the convex portion 43a to project outward from the housing 40, as illustrated in, for example, FIG. 4B. It should be noted that, in FIG. 4B, the amount of outward projection of the side plate portion 43 from the housing 40 is indicated by solid arrows. As described above, the deformation of the housing 40 relieves the external impact force applied to the housing 40.

### Effects

Next, the effects of the housing 40 will be described.

In the present example embodiment, the side plate portion 43 includes the band-shaped convex portion 43a that extends to reach both edges in the Y-direction (third direction) perpendicular or substantially perpendicular to the Z-direction (first direction) and the X-direction (second direction). The convex portion 43a includes the upper-side bent portion 43a2 that is inclined downward to the upper plate portion 41 from the plateau portion 43al of the convex portion 43a in the Z-direction and the lower-side bent portion 43a3 that is inclined downward to the second plate portion 42 from the plateau portion 43al of the convex portion 43a in the Z-direction. As a result, when external pressure is applied to the upper plate portion 41 or the lower plate portion 42 due to, for example, vibration or dropping during transportation, the pressure is relieved by the deformation of the upper-side bent portion 43a2 and the lower-side bent portion 43a3, and the convex portion 43a projects outward from the housing 40. As a result, when external pressure is applied to the upper plate portion 41 or the lower plate portion 42, the pressure applied to the accommodated object in the housing 40 can be reduced compared with the case in which the side plate portion 43 projects toward the accommodation space 50.

In the present example embodiment, the plateau portion 43a1 of the convex portion 43a is located at a position including the middle portion of the side plate portion 43 in the Z-direction. This can readily relieve pressure from the upper plate portion 41 and the lower plate portion 42 and reduce the amount of deformation of the housing 40.

In the present example embodiment, the upper plate portion 41, the lower plate portion 42, and the pair of side plate portions 43 are defined by separate metal plates. Accordingly, even when, for example, the side plate portion 43 is deformed, the upper plate portion 41 and the lower plate portion 42 can be suppressed from being deformed by the pressure applied by the deformation of the side plate portion 43.

In the present example embodiment, the end surface (the end surface of the upper-side plate portion 43b) of the side plate portion 43 at or adjacent to the upper plate portion 41 is in contact with the surface of the upper plate portion 41 at or adjacent to the lower plate portion 42, and the end surface (the end surface of the lower-side plate portion 43c) of the side plate portion 43 at or adjacent to the lower plate portion 42 is in contact with the surface of the lower plate portion 42 at or adjacent to the upper plate portion 41. This can suppress the pressure due to dropping or vibration, which is most likely to be applied, from being applied to the accommodated object.

In the present example embodiment, the upper plate portion 41 and the lower plate portion 42 have a U-shape. As a result, the end portions of the upper plate portion 41 and the lower plate portion 42 can come into contact with the end surfaces and the surfaces of the end portions of the side plate portions 43. As a result, for example, screwing as described above can be readily performed. In addition, the pressure due to dropping or vibration, which is most likely to be applied, can be suppressed from being applied to the accommodated object. It should be noted that contact between surfaces here includes not only contact between entire surfaces but also contact between portions of both surfaces with a gap partially provided therebetween.

In the present example embodiment, the folded portion 41b of the upper plate portion 41 overlaps at least a portion of the upper-side plate portion 43b in the X-direction, and the folded portion 42b of the lower plate portion 42 overlaps at least a portion of the lower-side plate portion 43c in the X-direction. As a result, when vertical pressure is applied, the end portions (the folded portions 41b and 42b) of the upper plate portion 41 and the lower plate portion 42 are pushed against both inclined surfaces of the convex portion 43a, and accordingly, both inclined surfaces of the convex portion 43a deform to relieve the pressure. As a result, the amount of outward deformation of the whole side plate portion 43 of the housing 40 can be reduced.

In the present example embodiment, the upper-side bent portion 43a2 and the lower-side bent portion 43a3 are symmetrical with respect to the middle portion of the side plate portion 43 in the Z-direction. This can readily relieve the pressure from the upper plate portion 41 and the lower plate portion 42 and reduce the amount of deformation of the housing 40.

In the present example embodiment, the upper-side bent portion 43a2 and the lower-side bent portion 43a3 are symmetrical with respect to the middle portion of the convex portion 43a in the Z-direction. This can readily relieve pressure from the upper plate portion 41 and the lower plate portion 42 and reduce the amount of deformation of the housing 40.

### 2. Modification

Next, a modification of the housing 40 according to an example embodiment will be described.

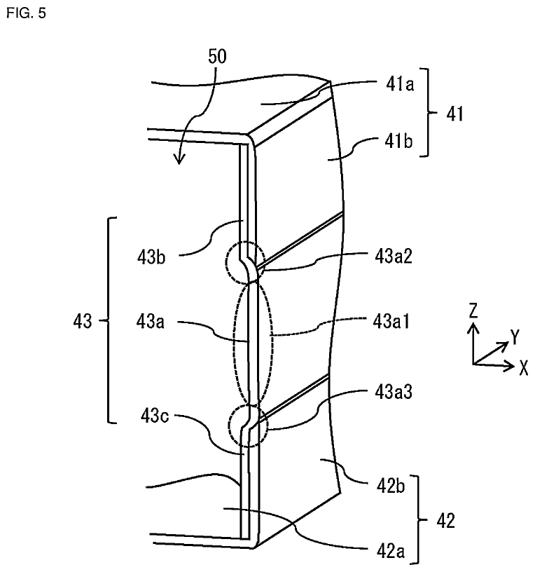

In the present example embodiment, as illustrated in, for example, FIG. 5, the end portion of the folded portion 41b may be located along the upper-side bent portion 43a2. At this time, the end portion of the folded portion 41b is in contact with the upper-side bent portion 43a2 or faces the upper-side bent portion 43a2. In addition, in the present example embodiment, as illustrated in, for example, FIG. 5, the end portion of the folded portion 42b may be located along the lower-side bent portion 43a3. At this time, the end portion of the folded portion 42b is in contact with the lower-side bent portion 43a3 or faces the upper-side bent portion 43a2. As a result, when pressure in the vertical direction is applied, the end portions (the folded portions 41B and 42b) of the upper plate portion 41 and the lower plate portion 42 are pushed against both inclined surfaces of the convex portion 43a, and accordingly, both inclined surfaces of the convex portion 43a deform to relieve the pressured. As a result, the amount of outward deformation of the whole side plate portion 43 of the housing 40 can be reduced.

In the example embodiments described above, the upper-side bent portion 43a2 and the lower-side bent portion 43a3 are symmetrical with respect to the middle portion of the side plate portion 43 in the Z-direction. However, in the example embodiments described above, the upper-side bent portion 43a2 and the lower-side bent portion 43a3 may be symmetrical with respect to a position closer to the upper plate portion 41 than the middle portion of the side plate portion 43 in the Z-direction or a position closer to the lower plate portion 42 than the middle portion of the side plate portion 43 in the Z-direction.

In the example embodiments described above, the upper-side bent portion 43a2 and the lower-side bent portion 43a3 are symmetrical with respect to the middle portion of the convex portion 43a in the Z-direction. However, in the example embodiments described above, the upper-side bent portion 43a2 and the lower-side bent portion 43a3 may be symmetrical with respect to a position closer to the upper plate portion 41 than the middle portion of the convex portion 43a in the Z-direction or to a position closer to the lower plate portion 42 than the middle portion of the convex portion 43a in the Z-direction.

In the example embodiments described above, the upper plate portion 41 and the lower plate portion 42 are U-shaped. However, in the example embodiments described above, the upper plate portion 41 and the lower plate portion 42 may be planar. However, in this case, both end portions of the upper plate portion 41 in the X-direction may be fixed to the end portions of the upper-side plate portion 43b, and both end portions of the lower plate portion 42 in the X-direction may be fixed to the end portions of the lower-side plate portion 43c.

In the example embodiments described above, the upper plate portion 41, the lower plate portion 42, and the pair of side plate portions 43 are defined by metal plates. However, in the example embodiments described above, at least one of the upper plate portion 41, the lower plate portion 42, and the pair of side plate portions 43 may be defined by a highly rigid resin plate.

Since the effects described herein are only examples, the effects of example embodiments of the present technology are not limited to the effects described herein. Accordingly, other effects of the present technology may be obtained.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A housing for electronic components, comprising:
a first plate portion and a second plate portion that are spaced apart from each other in a first direction; and
a third plate portion and a fourth plate portion that are spaced apart from each other in a second direction perpendicular or substantially perpendicular to the first direction, the third plate portion and the fourth plate portion being in contact with the first plate portion and the second plate portion; wherein
at least one of the third plate portion and the fourth plate portion includes a band-shaped convex portion that projects outward from the housing and extends to reach both edges in a third direction perpendicular or substantially perpendicular to the first direction and the second direction;
the convex portion includes a band-shaped plateau portion that extends in the third direction and a band-shaped first bent portion and a band-shaped second bent portion that are located on either side of the plateau portion in the first direction, the first bent portion and the second bent portion extending in the third direction;
the first bent portion includes a first slope portion in contact with an edge of the plateau portion at or adjacent to the first plate portion, the first slope portion extending from the plateau portion toward the first plate portion in the first direction; and
the second bent portion includes a second slope portion in contact with an edge of the plateau portion at or adjacent to the second plate portion, the second slope portion extending from the plateau portion toward the second plate portion in the first direction while being inclined in a direction opposite to a direction in which the first slope portion is inclined.

2. The housing for electronic components according to claim 1, wherein the plateau portion is located at a position including a middle portion in the first direction of the third plate portion or the fourth plate portion in which the convex portion is provided.

3. The housing for electronic components according to claim 1, wherein the first plate portion, the second plate portion, the third plate portion, and the fourth plate portion are defined by separate metal plates.

4. The housing for electronic components according to claim 3, wherein an end surface of the third plate portion and an end surface of the fourth plate portion that are at or adjacent to the first plate portion are in contact with surfaces of the first plate portion at or adjacent to the second plate portion, and an end surface of the third plate portion and an end surface of the fourth plate portion that are at or adjacent to the second plate portion are in contact with surfaces of the second plate portion at or adjacent to the first plate portion.

5. The housing for electronic components according to claim 4, wherein
the first plate portion has a U-shape that is in contact with surfaces of end portions of the third plate portion and the fourth plate portion that are at or adjacent to the first plate portion; and
the second plate portion has a U-shape that is in contact with surfaces of end portions of the third plate portion and the fourth plate portion that are at or adjacent to the second plate portion.

6. The housing for electronic components according to claim 5, wherein
the third plate portion or the fourth plate portion in which the convex portion is provided includes a fifth plate portion that extends from the first bent portion, the fifth plate portion being parallel or substantially parallel to the first direction, and a sixth plate portion that extends from the second bent portion, the sixth plate portion being parallel or substantially parallel to the first direction;
an end portion of the first plate portion at or adjacent to the third plate portion or the fourth plate portion in which the convex portion is provided overlaps at least a portion of the fifth plate portion in the second direction; and
an end portion of the second plate portion at or adjacent to the third plate portion or the fourth plate portion in which the convex portion is provided overlaps at least a portion of the sixth plate portion in the second direction.

7. The housing for electronic components according to claim 5, wherein
an end portion of the first plate portion at or adjacent to the third plate portion or the fourth plate portion in which the convex portion is provided is located along the first bent portion; and
an end portion of the second plate portion at or adjacent to the third plate portion or the fourth plate portion in which the convex portion is provided is located along the second bent portion.

8. The housing for electronic components according to claim 2, wherein the first bent portion and the second bent portion are symmetrical with respect to the middle portion in the first direction of the plate portion in which the convex portion is provided.

9. The housing for electronic components according to claim 2, wherein the first bent portion and the second bent portion are symmetrical with respect to a middle portion in the first direction of the convex portion.

10. The housing for electronic components according to claim 1, wherein the first plate portion, the second plate portion, the third plate portion, and the fourth plate portion are configured to accommodate at least one of a secondary battery and a circuit board.

11. The housing for electronic components according to claim 1, wherein the housing is a housing for battery units in which a battery unit is accommodated.

12. A power supply device comprising:
a battery unit; and
a housing for battery units in which the battery unit is accommodated; wherein
the housing for battery units includes a first plate portion and a second plate portion that are spaced apart from each other in a first direction and a third plate portion and a fourth plate portion that are spaced apart from each other in a second direction perpendicular or substantially perpendicular to the first direction, the third plate portion and the fourth plate portion being in contact with the first plate portion and the second plate portion;
at least one of the third plate portion and the fourth plate portion includes a band-shaped convex portion that projects outward from the housing and extends to reach both edges in a third direction perpendicular or substantially perpendicular to the first direction and the second direction;
the convex portion includes a band-shaped plateau portion that extends in the third direction and a band-shaped first bent portion and a band-shaped second bent portion that are located on either side of the plateau portion in the first direction, the first bent portion and the second bent portion extending in the third direction;
the first bent portion includes a first slope portion in contact with an edge of the plateau portion at or adjacent to the first plate portion, the first slope portion extending from the plateau portion toward the first plate portion in the first direction; and
the second bent portion includes a second slope portion in contact with an edge of the plateau portion at or adjacent to the second plate portion, the second slope portion extending from the plateau portion toward the second plate portion in the first direction while being inclined in a direction opposite to a direction in which the first slope portion is inclined.

13. The power supply device according to claim 12, wherein the plateau portion is located at a position including a middle portion in the first direction of the third plate portion or the fourth plate portion in which the convex portion is provided.

14. The power supply device according to claim 12, wherein the first plate portion, the second plate portion, the third plate portion, and the fourth plate portion are defined by separate metal plates.

15. The power supply device according to claim 14, wherein an end surface of the third plate portion and an end surface of the fourth plate portion that are at or adjacent to the first plate portion are in contact with surfaces of the first plate portion at or adjacent to the second plate portion, and an end surface of the third plate portion and an end surface of the fourth plate portion that are at or adjacent to the second plate portion are in contact with surfaces of the second plate portion at or adjacent to the first plate portion.

16. The power supply device according to claim 15, wherein
the first plate portion has a U-shape that is in contact with surfaces of end portions of the third plate portion and the fourth plate portion that are at or adjacent to the first plate portion; and
the second plate portion has a U-shape that is in contact with surfaces of end portions of the third plate portion and the fourth plate portion that are at or adjacent to the second plate portion.

17. The power supply device according to claim 16, wherein
the third plate portion or the fourth plate portion in which the convex portion is provided includes a fifth plate portion that extends from the first bent portion, the fifth plate portion being parallel or substantially parallel to the first direction, and a sixth plate portion that extends from the second bent portion, the sixth plate portion being parallel or substantially parallel to the first direction;
an end portion of the first plate portion at or adjacent to the third plate portion or the fourth plate portion in which the convex portion is provided overlaps at least a portion of the fifth plate portion in the second direction; and
an end portion of the second plate portion at or adjacent to the third plate portion or the fourth plate portion in which the convex portion is provided overlaps at least a portion of the sixth plate portion in the second direction.

18. The power supply device according to claim 16, wherein
an end portion of the first plate portion at or adjacent to the third plate portion or the fourth plate portion in which the convex portion is provided is located along the first bent portion; and
an end portion of the second plate portion at or adjacent to the third plate portion or the fourth plate portion in which the convex portion is provided is located along the second bent portion.

19. The power supply device according to claim 13, wherein the first bent portion and the second bent portion are symmetrical with respect to the middle portion in the first direction of the plate portion in which the convex portion is provided.

20. The power supply device according to claim 13, wherein the first bent portion and the second bent portion are symmetrical with respect to a middle portion in the first direction of the convex portion.
